(19) United States
(12) Patent Application Publication
(10) Pub. No.: US 2010/0236355 A1
(43) Pub. Date: Sep. 23, 2010

(54) VARIABLE ECCENTRICITY ASSEMBLY

(76) Inventor: Vishvas Prabhakar Ambardekar, Maharashtra (IN)

Correspondence Address: Ambradekar Vishvas;Snehal Apartments, Flat No 1 Plot No B-82, Tulshibagwale Colony Sahakar Nagar No 2, Pune, 411009, IN

(21) Appl. No.: 12/734,348

(22) PCT Filed: Apr. 3, 2008
(86) PCT No.: PCT/IN2008/000214

§ 371 Date: Apr. 27, 2010

(30) Foreign Application Priority Data
Oct. 26, 2007 (IN) 2127-MUM-2007

(51) Int. Cl. F16C 3/28; F16C 3/22

(52) U.S. Cl. 74/571.11

(57) ABSTRACT

The invention describes a variable eccentricity assembly, in which the overall eccentricity of the assembly can be changed while continuing rotation of the assembly. Two types of assemblies to change the eccentricity of the assembly are described. In one type multiple eccentric parts are arranged in series, and a relative rotation between them varies the eccentricity of the assembly and in second type a disc is moved in a direction normal to the shaft to vary the overall eccentricity of the assembly. The variable eccentricity assembly can be used in eccentric gearbox, eccentric gear drives, eccentric clutches and in other various-applications. It can also be used in many applications to compensate wear and tear. Use of variable eccentricity assembly can also save maintenance efforts in some applications.

### BACKGROUND

Many mechanisms use crank and eccentric parts, mainly for forcing an axis to revolve around a reference axis, which is generally a fixed axis. For example crank pin axis of a crank revolves around the crank axis similarly axis of a circular disc that is used as an eccentric part revolves around its axis of revolution; crank axis and axis of revolution of an eccentric part work as fixed reference axes. In almost all the cases, distance between reference axis and revolving axis is constant and is known as crank radius for a crank and eccentricity for an eccentric part. A crank with some crank radius is kinematically equivalent to an eccentric part with eccentricity equal to the crank radius.

Present invention suggests mechanisms to give variable eccentricity for an assembly. The invented mechanism can change eccentricity of an assembly called variable eccentricity assembly as needed by a machine or by an apparatus or by a device for its operation. With present invention, it is possible to use some value of eccentricity for some duration and use some other value of eccentricity for some other duration, during operation of a machine. Thus, with present invention it is possible to select any value within two set designed values of eccentricity at any time during operation of a machine that uses such a variable eccentricity assembly. A variable eccentricity assembly is very useful for eccentric gear drives and in many other industrial applications where change in eccentricity is useful.

### PRIOR ART

1. U.S. Pat. No. 4,776,156, dated Oct. 11, 1988 titled as “Variable eccentricity mass for mechanical shakers” invented by Galen K. Brown, Henry A. Affeldt, Jr., Thomas A. Esch, and Richard J. Wolthuis. It describes an eccentric mass, which can be moved away from a shaft axis that supports the mass as to incorporate change in the vibration by changing the location of an eccentric mass with respect to the rotating shaft that carries the mass.

2. U.S. Pat. No. 7,064,655 B2, dated Jun. 20, 2006 titled as “Variable Eccentricity Tactile Generator” invented by Matthew J. Murray, Michael Townsend, Chris Eaton, and Gregory S. Patterson. It describes a tactile generator with an eccentric mass that imparts a vibration as it rotates about a rotational axis. The mass is radially movable with respect to the rotational axis such that the distance between the mass and the axis is variable. Varying the distance of the mass from the axis varies the amount of vibration generated when the mass is rotated. The amount of vibration may be controlled responsive to a detected level of ambient noise.

### INTRODUCTION

Different types of machines regularly use cranks and eccentric parts. Few of the important uses of eccentric parts or cranks are found within eccentric gear drive, eccentric gearbox, and in reciprocating piston mechanisms. Eccentric gear drive and eccentric gearbox are characterized to give very high speed-ratio between input and output shafts and are very compact as compared to conventional gear drive and conventional gearbox. Eccentric parts or cranks, used for eccentric gearbox and other machines usually have constant eccentricity. Present mechanism gives provision to change effective eccentricity or overall eccentricity of a variable eccentricity assembly as and when needed for better operation of the machine.

### Definitions:

Eccentricity: When an axis revolves around another parallel axis, then eccentricity is the distance between the two axes. When these two axes are aligned, the eccentricity becomes zero.

Eccentric part: An eccentric part is a part which when rotated about a first axis forces a second axis to revolve around the first axis, the distance between the two axes is the eccentricity of the part. An eccentric part can be a circular disc with a non-concentric hole. A basic eccentric part as a disc has at least a portion of individual external and internal surfaces as surfaces of revolution with their geometric axes parallel to each other; the distance between these two axes is the eccentricity of the eccentric part. A circular disc with a shaft, as an eccentric part, does not have a hole in it but, as the disc rotates about the shaft axis, the distance between the shaft axis (first axis) to the axis of the disc (second axis) is the eccentricity of the disc as an eccentric part. For ease of understanding, internal and external surfaces of eccentric parts are considered cylindrical and their respective axes are called as first axis and second axis. Henceforth an eccentric part is called as an eccentric in singular form and as eccentrics in plural form.

### BRIEF DESCRIPTION OF THE INVENTION

In most applications, eccentrics experience eccentric loads while revolving around the axis of revolution called as reference axis. Thus, when a variable eccentricity assembly is used, it should be able of withstand the eccentric load while revolving around reference axis and simultaneously maintain overall eccentricity at a desired value or in a changeable state as per the operational requirements of the device.

To achieve variable eccentricity following arrangements are proposed:

First arrangement with eccentrics in series: In this arrangement, at least two eccentrics are used in series in such a way that the first axis of one eccentric is aligned to the second axis of another eccentric; while the two eccentrics are free to rotate with respect to each other. Relative rotation of eccentrics in series is controlled by some mechanism and overall eccentricity is governed by relative angular positions of these eccentrics. These multiple eccentrics together in series is called as combination assembly of eccentrics and acts as a single eccentric during usual operation of a machine that uses it. In a combination assembly of eccentrics, eccentricity of individual eccentric is independent of each other.

Though any number of eccentrics can be arranged in series in a combination assembly of eccentrics, in such a way that an eccentric is allowed to rotate with respect to another eccentric, arrangements with only two eccentrics in series are discussed here to explain the mechanism to give variable eccentricity. A person skilled in the art can easily make out how to put more than two eccentrics in series in a combination assembly of eccentrics to get variable eccentricity from it. Eccentrics arranged in series preferably have parallel axes.

Second arrangement with transverse movement of disc: In this arrangement, at least one disc, with a portion of external surface as a surface of revolution, is mounted on a reference axis, in such a way that the disc and thus its axis can move in a direction normal to the reference axis. In other words, the disc can move in a radial direction. Disc axis is maintained parallel to the reference axis. This movement of the disc causes variation in overall eccentricity of the assembly, which is the distance from the disc axis to the reference axis.

Third arrangement as combination of first and second arrangements: This arrangement is a combination of the two arrangements mentioned above and thus not discussed further in detail. A person skilled in the art, can easily find out appropriate ways to use above-mentioned arrangements together for making a single variable eccentricity assembly to give variation in its overall eccentricity. In this arrangement, at least one of the eccentrics or at least one disc can move in a direction normal to the reference axis as in second arrangement and at least one eccentric is mounted in series with it as in first arrangement. Other combinations of above-mentioned arrangements can also be worked out as per the requirements of the device that use the variable eccentricity assembly.

The invention is explained with the help of following figures:

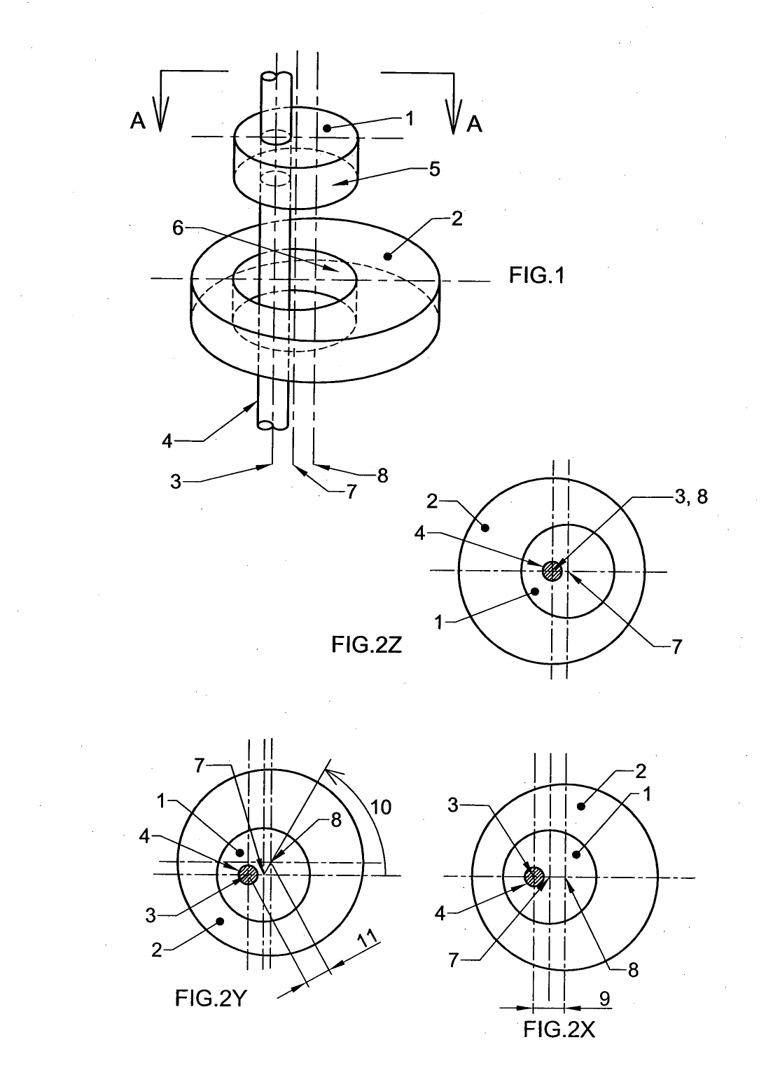

FIG. 1: Schematic representation of two eccentrics in series; for ease of understanding, the eccentrics are displaced along the axis of shaft.

FIG. 2X, FIG. 2Y, FIG. 2Z: Schematic views of three different relative angular positions of the two eccentrics in series as shown in FIG. 1, when viewed in direction AA.

FIG. 2X: Schematic view of relative angular positions of two eccentrics in series, as shown in FIG. 1, when their individual eccentricities are in phase with each other that give maximum overall eccentricity for the combination of the eccentrics.

FIG. 2Y: Schematic view of relative angular positions of two eccentrics in series, as shown in FIG. 1, when one eccentric is rotated with respect to other.

FIG. 2Z: Schematic view of relative angular positions of two eccentrics in series, as shown in FIG. 1, when their individual eccentricities are out of phase with each other that give minimum overall eccentricity for the combination of the eccentrics.

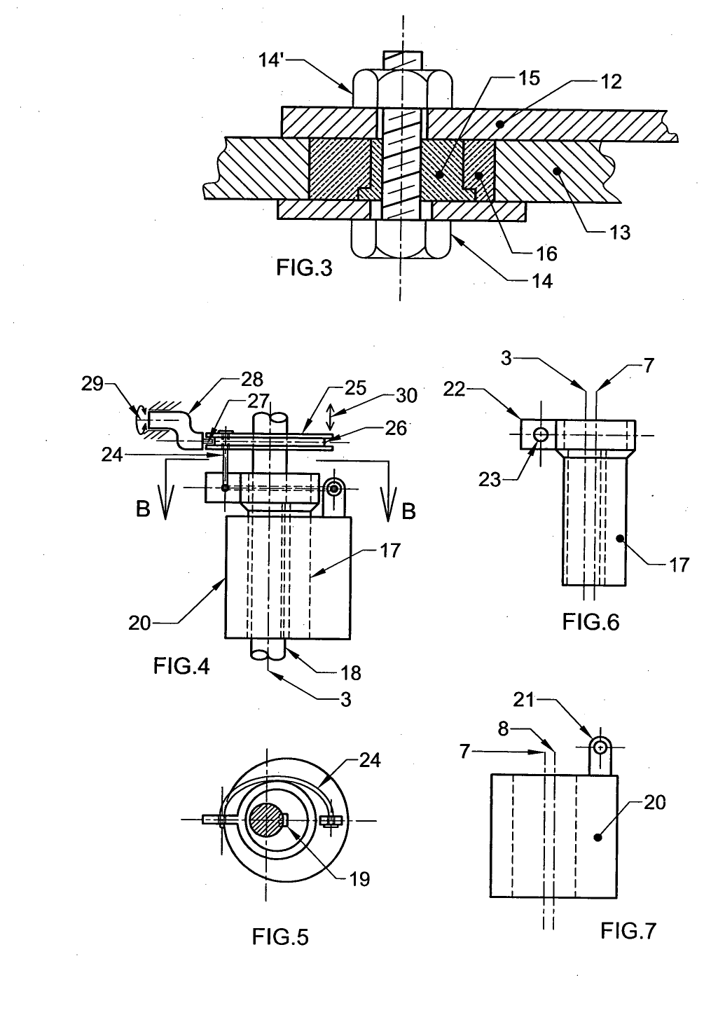

FIG. 3: Schematic representation of a spacer or a fastener made of a combination assembly of eccentrics with two eccentrics, for mounting a device.

FIG. 4: Schematic arrangement for a combination assembly of eccentrics to relatively rotate two eccentrics with respect to each other, as to vary overall eccentricity of the assembly. Overall eccentricity is shown at its maximum.

FIG. 5: Schematic representation of sectional view taken at BB, of the combination assembly of eccentrics that is shown in FIG. 4.

FIG. 6: Schematic representation of inner eccentric belonging to the combination assembly of eccentrics that is shown in FIG. 4.

FIG. 7: Schematic representation of outer eccentric belonging to the combination assembly of eccentrics that is shown in FIG. 4.

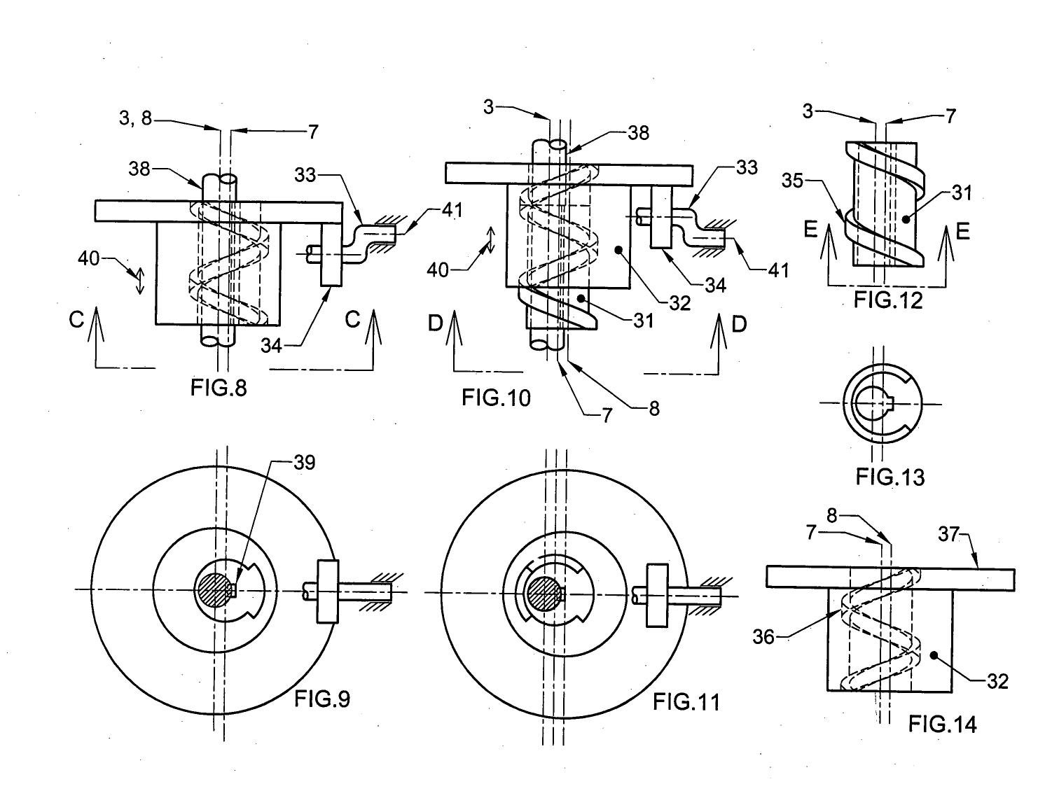

FIG. 8: An alternative schematic arrangement, different from the one shown in FIG. 4, for a combination assembly of eccentrics to relatively rotate two eccentrics with respect to each other, as to vary overall eccentricity of the assembly. Overall eccentricity is shown at its minimum.

FIG. 9: A schematic view of the combination assembly of eccentrics that is shown in FIG. 8, when seen in direction CC.

FIG. 10: Schematic representation of the combination assembly of eccentrics as shown in FIG. 8, when eccentricities of individual eccentrics are in phase with each other and the overall eccentricity of the assembly is at its maximum.

FIG. 11: A schematic view of the combination assembly of eccentrics that is shown in FIG. 10, when seen in direction DD.

FIG. 12: Schematic representation of inner eccentric belonging to the combination assembly of eccentrics that is shown in FIG. 8 and FIG. 10.

FIG. 13: A schematic view of inner eccentric that is shown in FIG. 12, when seen in the direction EE.

FIG. 14: Schematic representation of outer eccentric belonging to the combination assembly of eccentrics that is shown in FIG. 8 and FIG. 10.

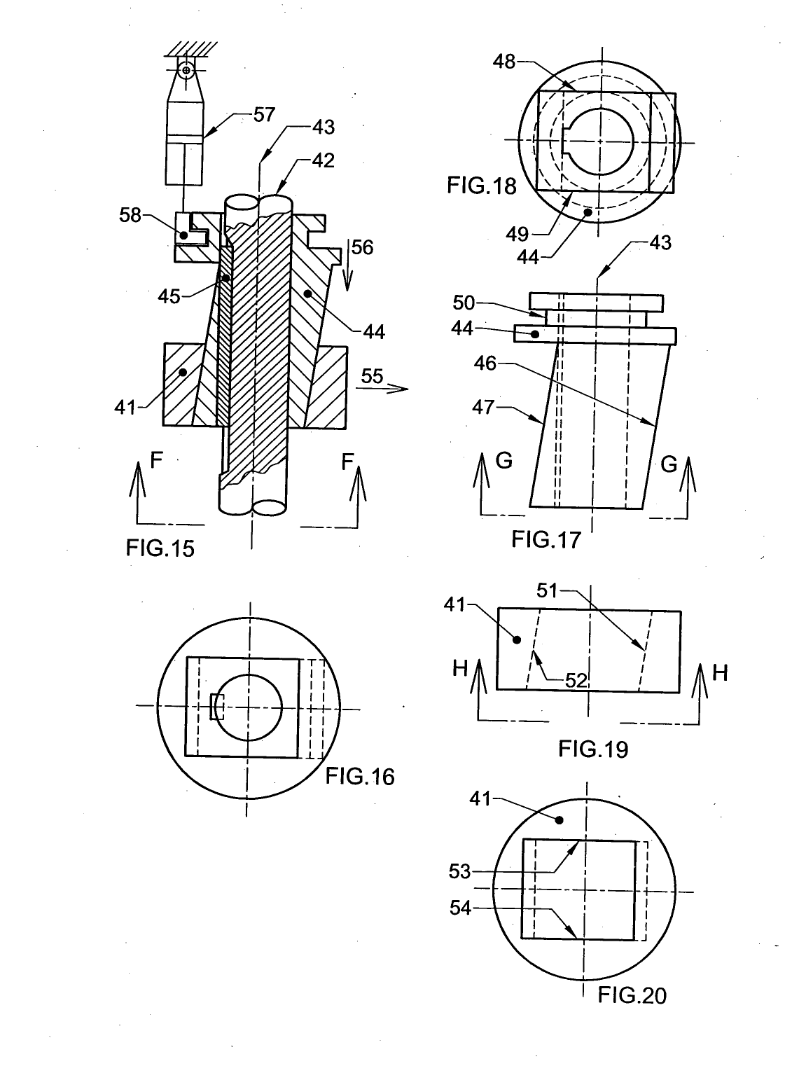

FIG. 15: Cross-sectional view of a schematic assembly with an arrangement to move a disc in transverse direction to give variable eccentricity for the assembly.

FIG. 16: A schematic view of the assembly that is shown in FIG. 15, when seen in direction FF.

FIG. 17: A schematic view of the part belonging to the assembly shown in FIG. 15, which moves the disc in a direction normal to the shaft axis to vary overall eccentricity for the assembly.

FIG. 18: A schematic view of the part that is shown in FIG. 17, when seen in direction GG.

FIG. 19: Schematic view of the disc that gives variable eccentricity when used in an assembly that is shown in FIG. 15.

FIG. 20: A schematic view of the disc that is shown in FIG. 19, when seen in direction HH.

FIG. 21: Cross-sectional view of a schematic assembly with an alternative arrangement, different from the one shown in FIG. 15, to move a disc in transverse direction to give variable eccentricity for the assembly.

FIG. 22: Schematic view of a part belonging to the arrangement as shown in FIG. 21 that moves in a direction along the shaft axis.

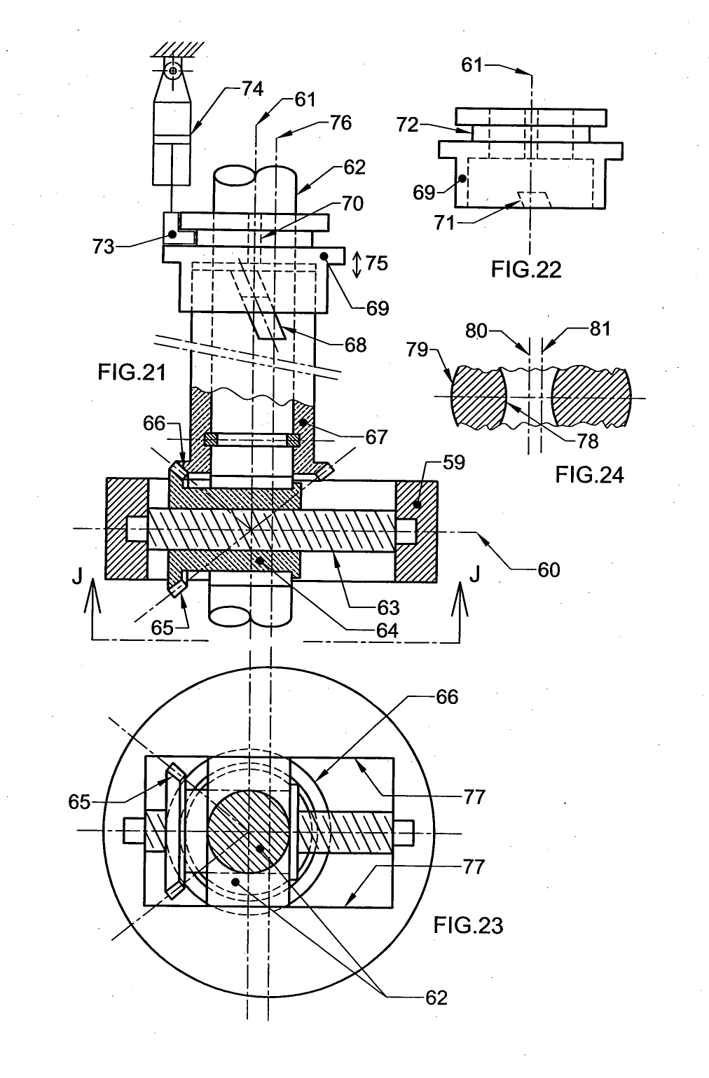

FIG. 23: Schematic view of the arrangement that is shown in FIG. 21, when seen in direction JJ.

FIG. 24: Sectional view along the two axes of a schematic partial eccentric part with non-cylindrical internal and external surfaces.

### DETAILED DESCRIPTION OF THE INVENTION

FIG. 1 shows a schematic combination assembly of eccentrics, with two eccentrics 1 and 2 separated from each other along the shaft axis 3. For ease of understanding, both eccentrics are shown with internal and external surfaces as cylindrical surfaces. Eccentric 1 is fixed to the shaft 4 as to rotate with shaft 4. Eccentric 2 is mounted in a matching cavity on an output component and is free to rotate with respect to it. The output component that uses the variable eccentricity is not shown in figures. Eccentrics 1 and 2 are mounted in series and are free to rotate with respect to each other.

Second axis or axis of external surface 5 of eccentric 1 and first axis or axis of internal surface 6 of eccentric 2 are aligned and are represented by axis 7. Second axis or axis of external surface of eccentric 2 is represented by 8. First axis of eccentric 1 is the same as the shaft axis 3. Eccentricity of inner eccentric 1 is the distance between its first axis 3 and second axis 7, and that of outer eccentric 2 is the distance between its first axis 7 and second axis 8. Overall eccentricity of the combination assembly is the distance between axes 3 and 8 and can be changed by rotating eccentric 2 with respect to eccentric 1 about axis 7. By controlling relative rotation of eccentric 2 with respect to eccentric 1, overall eccentricity of the combination assembly of eccentrics as shown in FIG. 1 can be controlled.

FIG. 2X, FIG. 2Y, FIG. 2Z show three relative angular positions of eccentrics 1 and 2 in a combination assembly of eccentrics, and overall eccentricity thereof. For this example only two eccentrics with equal eccentricities in series are considered, though there can be more eccentrics in series with their individual eccentricities being independent of each other.

FIG. 2X schematically displays relative angular positions of two eccentrics 1 and 2 when both eccentrics are in phase with each other and overall eccentricity that is the distance between axes 3 and 8, is at its maximum and is represented by 9. In other words the three axes 3, 7, and 8 become co-planer.

FIG. 2Y schematically shows relative angular position of eccentric 2, when rotated with respect to eccentric 1 by an angle represented by 10, from the state as shown in FIG. 2X. Again overall eccentricity is the distance between axes 3 and 8 and is represented by 11.

FIG. 2Z schematically shows relative angular position of eccentric 2, when rotated with respect to eccentric 1 by 180°, from the state as shown in FIG. 2X. Again overall eccentricity is the distance between the axes 3 and 8 and is at its minimum; three axes 3, 7, and 8 are co-planer. In present case, as the two individual eccentricities are equal and are out of phase, first axis 3 of eccentric 1 and second axis 8 of eccentric 2 are aligned, and overall eccentricity becomes zero.

Thus by mounting multiple eccentrics in series, in such a way that eccentrics have relative rotation between them, overall eccentricity can be changed by changing relative angular displacement of the eccentrics. For ease of understanding, henceforth axes of shaft, inner eccentric and outer eccentric are represented by 3, 7, and 8 respectively for a combination assembly of eccentrics with two eccentrics.

FIG. 3, schematically displays one probable use of eccentrics mounted in series. Parts 12 and 13 with appropriate holes are to be held together with the help of a threaded bolt 14 and a nut 14′. If alignment between 12 and 13 is very poor and if we just put a bolt 14 through 12 and 13, and tighten the nut 14′ on other end, the joint may get excessive stress due to improper alignment. In similar situations, an assembly with multiple eccentrics as shown in FIG. 3 can be of advantage. As shown in FIG. 3, bolt 14 is inserted through inner eccentric 15 that is supported by outer eccentric 16, which is free to rotate within the hole provided in 13. By rotating 15 and 16, axis of the bolt 14 can easily be located anywhere within a cylindrical space of radius equal to the obtainable maximum eccentricity of the combination assembly of eccentrics 15 and 16, with cylinder axis aligned to the axis of external surface of 16. Assuming 13 as fixed, axis of external surface of outer eccentric 16 becomes its first axis and axis of its internal surface becomes its second axis. Axis of external surface of inner eccentric 15 becomes its first axis, which is aligned to the second axis of outer eccentric 16 as the two are arranged in series. Thus, improper alignment can be taken care of by use of combination assembly of eccentrics with variable eccentricity.

Eccentrics are mainly used to maintain distance between two axes while revolving one axis about the other axis. Thus, an assembly that has variable eccentricity should be able to maintain the eccentricity while in revolution. Few configurations are developed and described further to relatively rotate eccentrics in series, and simultaneously maintain their relative angular positions while the assembly revolves. Different configurations that use eccentrics in series for varying overall eccentricity of a combination assembly of eccentrics are described below.

First configuration to give direct relative rotation of the eccentrics: FIG. 4 shows a combination assembly of eccentrics with inner eccentric 17 fixed to shaft 18 with a key 19. Outer eccentric 20 is mounted in series with inner eccentric 17 and is free to rotate with respect to 17. A projection 21 is located on eccentric 20, another projection 22 with an opening 23 in it, is located on eccentric 17. Individual eccentrics 17 and 20 are shown in FIG. 6 and FIG. 7 respectively.

FIG. 5 shows a schematic sectional view of the combination assembly as shown in FIG. 4, when viewed in direction BB. FIG. 5 shows a flexible member or a flexible steel wire 24 of fixed length, with its one end fixed to projection 21. The flexible wire is routed through opening 23, with its other end fixed to a ring 25. Ring 25 is fixed to shaft 18 such that it rotates with the shaft and is free to move in direction along the shaft axis. This is achieved by providing an axial groove on the shaft 18 with a matching projection on ring 25 as to slide it within the groove. Ring 25 is provided with a groove 26 on its outer circumference. A pin 27 that is located in groove 26, is attached to a crank 28 that revolves around a fixed crank axis 29.

To oppose tension in flexible wire 24 and to maintain relative angular positions of the eccentrics, a mechanism that is not shown in figures is employed; though few of such mechanisms are suggested here. A spring can be placed between projections 21 and 22, or yet another wire can be placed between projections 21 and 22 as to oppose tension in wire 24. Flexible wire 24, itself can be routed between projections 21 and 22 in a way that torque experienced by shaft 18 due to eccentric load caused by rotation of the combination assembly opposes tension in flexible wire 24. Thus with a suitable mechanism to oppose tension in flexible wire 24, outer eccentric 20 can be maintained in any angular position with respect to the inner eccentric 17.

When crank 28 is rotated about axis 29, pin 27 moves ring 25 in direction 30 along shaft axis 3. While ring 25 rotates with shaft 18, pin 27 slides in groove 26. Independent of the shaft rotation, movement of ring 25 along direction 30, moves projection 21 in relation with projection 22 and rotates outer eccentric 20 with respect to inner eccentric 17, with the help of flexible wire 24. Thus, rotation of crank 28, through movement of ring 25 determines relative angular position of outer eccentric 20 with respect to the inner eccentric 17.

Thus, when crank 28 is locked in a position, ring 25 gets a fixed position on shaft 18; outer eccentric 20 gets a fixed position with respect to inner eccentric 17, through flexible wire 24 and a mechanism to oppose tension in wire 24. Thus with ring 25 in fixed position, parts 17, 20, 24, and 25 revolve with shaft 18 and maintain overall eccentricity of the combination assembly during revolution of shaft 18. Thus by maintaining position of ring 25 on the shaft, overall eccentricity of the combination assembly can be maintained at any value of eccentricity between maximum and minimum values of eccentricity obtainable from the combination assembly of eccentrics with multiple eccentrics in series.

Various alternative arrangements of first configuration: An example of variable eccentricity assembly is described above to explain the working principle of first configuration. It is possible to use various arrangements of multiple eccentrics in series with mechanisms, to rotate one eccentric with respect to another one. To name few of the arrangements, a hydraulic actuator, a pneumatic actuator, an electronically operated actuator, or some other type of actuator can be employed to control movement of ring 25 in axial direction 30, instead of the arrangement with crank 28 and pin 27. In yet another arrangement, an actuator can be connected directly between two projections 21 and 22 and thus connected directly between the two eccentrics instead of flexible wire 24, as to directly control relative rotation of eccentrics, without the need of the axially movable ring 25.

In yet another combination of the above described configuration, outer eccentric can be fixed to the output component, while the inner eccentric is free to rotate with respect to the shaft.

In all the arrangements above that use flexible member 24, one end of the flexible member is fixed to the outer eccentric and other end to the ring while the flexible member is routed through the inner eccentric as shown in FIG. 4. On the other hand, in yet other alternative combination, one end of the flexible member can be fixed to. the inner eccentric and other end to the ring while the flexible member is routed through the outer eccentric. For all the combinations with ring 25, as mentioned above, the ring is movable with respect to the eccentrics along the axis of the shaft, and the ring is made to rotate either with inner eccentric or with outer eccentric or with shaft as per specific requirements of the application.

In an application where a tendency to change the eccentricity is intended, a stretchable or compressible element like a spring can also be put within the length of the flexible member or in between the two eccentrics.

A person skilled in the art can work out other arrangements to control relative rotation of eccentrics mounted in series in a combination assembly of eccentrics to vary its overall eccentricity while allowing it to revolve.

Second configuration to give indirect relative rotation of the eccentrics: FIG. 8 shows another assembly with inner eccentric 31, outer eccentric 32, crank 33 together with freely rotating wheel 34. Eccentrics 31 is provided with a helical projection 35 and eccentric 32 is provided with helical groove 36 that matches with 35, and also with a collar 37. Eccentrics 31 and 32 are respectively shown in FIG. 12 and FIG. 14. A schematic view of inner eccentric 31 when viewed in direction EE, is shown in FIG. 13.

As eccentrics 31 and 32 are assembled together in series, with helical projection on one eccentric matching with helical groove on other eccentric, a relative movement along axial direction between the two eccentrics causes corresponding relative rotation between them. One of the eccentrics 31 and 32 is made movable and other is made fixed in the axial direction for easy control of relative axial movement between them. In present assembly, inner eccentric 31 is fixed on shaft 38 with key 39, as to rotate with the shaft and does not move in axial direction 40. Outer eccentric 32 is made movable in the axial direction 40 and is free to rotate with respect to the output component that has a provision for axial movement of 32. Output component is not shown in figures. Helical groove and matching projection convert relative axial movement between the two eccentrics into corresponding relative rotation between them.

As shaft 38 together with the two eccentrics revolves, a torque is experienced on the shaft. This torque causes an equal and opposite axial force on the eccentrics, direction and magnitude of which depends on direction of torque experienced by the shaft, and angle and direction of helix of the helical projection and groove. This axial force induces a tendency in the movable eccentric, in this case eccentric 32, to move along the axial direction. Assuming that in present application, movable outer eccentric 32 has a tendency to move axially downwards, a freely rotating wheel 34 mounted on a crank 33 with crank axis 41 is provided to support eccentric part 32 through collar 37 from below. Thus by rotating crank 33 around fixed axis 41, freely rotating wheel 34 moves outer eccentric 32 in axial direction and correspondingly rotates it with respect to inner eccentric 31. Thus by locking crank 33 in a position, any required relative angular position of outer eccentric 32 with respect to inner eccentric 31 can be maintained. As the relative rotation of one eccentric with respect to the other eccentric determine overall eccentricity of the combination assembly of eccentrics; overall eccentricity can be controlled by controlling movement of crank 33 around crank axis 41 while freely rotating wheel 34 allows the assembly to continue rotation for any position of the crank 33.

For present combination assembly of eccentrics as shown in FIG. 8, eccentricities of the two eccentrics 31 and 32 mounted in series are chosen to be equal. FIG. 8 and FIG. 9 show the combination assembly of eccentrics when eccentricities of individual eccentrics are out of phase with each other, thus overall eccentricity is zero. FIG. 10 and FIG. 11 show the combination assembly of eccentrics when eccentricities of individual eccentrics are in phase with each other, thus overall eccentricity is at its maximum.

Various arrangements of second configuration: An example of variable eccentricity assembly is described above to explain the working principle of second configuration. In another arrangement of second configuration, a hydraulic actuator, a pneumatic actuator, an electronically operated actuator or some other actuator can be used, instead of crank 33 and freely rotating wheel 34, to control the axial movement of eccentric 32, in direction 40. In yet another alternative arrangement, a helical projection can be made on outer eccentric with a matching helical groove provided on inner eccentric.

Different combinations of above-mentioned mechanism with helical projection and groove are possible. The combination should have either inner or outer eccentric movable along shaft axis while, either inner eccentric is made to rotate with the shaft and outer eccentric is free to rotate with respect to the output component, or inner eccentric is free to rotate with respect to the shaft and outer eccentric is made to rotate with the output component. According to the specific combination, suitable mechanism is to be employed to control relative axial movement of the eccentrics.

Two configurations as mentioned above are variants of arrangements that use two eccentrics in series and the relative rotation between them is used to control overall eccentricity of the combination assembly of eccentrics. In all configurations with two eccentrics in series, use of eccentrics with different individual eccentricities can set obtainable minimum overall eccentricity to a non-zero value. Using the principle stated in above-mentioned examples, more than two eccentrics can be arranged in series with both the configurations. A person skilled in the art can employ a suitable mechanism to control relative rotation of one eccentric with respect to another eccentric in series.

Configuration to move a disc in a direction normal to the shaft axis: This configuration consists of a disc attached to a shaft in such a way that the disc axis is parallel to the shaft axis and the disc is movable in a direction normal to the shaft axis. Distance between the axis of the shaft and that of the disc is the overall eccentricity of the assembly and thus can be changed by appropriately moving the disc in a direction normal to the shaft axis. In most cases, the disc is restrained from moving along the direction of the shaft axis. The disc mentioned above has external surface as a surface of revolution formed by revolving a curve around an axis, which is the disc axis.

In some applications, the disc can be moved when the shaft is not rotating, for such applications any mechanism that gives linear motion can be used as after setting overall eccentricity or distance between axis of the shaft and that of the disc, the disc can be appropriately locked in the desired position and the shaft rotation can be resumed. The mechanism should also be able to withstand forces coming onto it and simultaneously maintain the distance between axis of the shaft and that of the disc during rotations of the shaft and the disc.

Two such possible mechanisms are described below to move the disc in a direction normal to the shaft axis. The mechanisms can move the disc while the assembly continues to revolve around the shaft axis

FIG. 15 shows a schematic assembly, and FIG. 16 shows its view when viewed in direction FF, that utilizes above-mentioned configuration for varying overall eccentricity of the assembly. Disc 41 is mounted on an output component, which makes use of varying eccentricity of the assembly, in such a way that it is able to rotate freely with respect to the output component. Shaft 42 has its axis of rotation 43. An intermediate part 44 is mounted on shaft 42 and is movable in direction along axis 43. Disc 41 is mounted on the intermediate part 44. Shaft 42, disc 41 and intermediate part 44 rotate together without relative rotation between them. To mount intermediate part 44 on the shaft in the said manner, it is possible to make shaft 42 as a splined shaft and make part 44 with matching splines on to it. Part 44 can also be mounted on the shaft with a key 45 fixed to it and providing a matching grove on to the part 44 as schematically shown in FIG. 15.

Intermediate part 44 is schematically shown in FIG. 17 with another view as seen in direction GG in FIG. 18. It has two opposing slant surfaces 46 and 47 and has another two opposing surfaces 48 and 49. The four surfaces 46, 47, 48 and 49 are shown as flat surfaces for ease of understanding; while in an application the surfaces need not be flat surfaces. Coaxial to the shaft axis 43 a groove 50, with a suitable cross-section is provided on an outer circumference of part 44.

Schematic disc 41 is shown in FIG. 19 and it's another view as seen in direction HH is shown in FIG. 20. The disc has two opposing surfaces 51 and 52 that match with surfaces 46 and 47 respectively. The disc also has other two opposing surfaces 53 and 54 that match with the surfaces 48 and 49.

In the assembly as shown in FIG. 15, disc 41 has no relative rotation with respect to shaft 42 and is restrained to move in direction along the axis of the shaft. The disc surfaces 51, 52, 53, and 54 are supported by surfaces 46, 47, 48 and 49 respectively. As the disc is not allowed to move in axial direction, slant surface pairs 46, 51 and 47, 52 move disc 41 in direction 55 that is normal to the shaft axis 43, for a corresponding movement of part 44 in axial direction 56. Similarly for a movement of part 44 in direction opposite to 56, disc 41 moves in direction opposite to 55. Surface pairs 48, 53 and 49, 54 block any movement of disc 41 in direction normal to 55 in a plane normal to shaft axis. Above-mentioned four surface pairs provide stability to the disc 41 and transfer the load from the disc to the shaft while in operation. As schematically shown in FIG. 15, an actuator 57 is provided to move part 44 in the direction along axis 43 through part 58 that slides within the groove 50 and has a matching cross-section. Thus, actuator 57 through part 58 can control movement of part 44 in direction 43 and thus moves disc 41 in a direction normal to the shaft axis as to change the overall eccentricity of the assembly while assembly continues to revolve about axis 43.

In another arrangement as shown in FIG. 21, disc 59 has controlled movement, in a direction 60 that is normal to the axis 61 of the shaft 62, through threaded member 63 that is fixed to the disc 59. Nut 64, matching with the threaded member 63, is fixed to shaft 62 in such a way that it rotates with the shaft and has no movement along axes 61 and 60. Nut 64 is free to rotate about axis 60 and is fixed with a bevel gear 65 at one end. A bevel gear 66 in mesh with bevel gear 65, is fixed to an assembly 67 that is mounted on shaft 62 such that it is free to rotate with respect to the shaft and does not move in axial direction 61. Assembly 67 is provided with a helical groove 68. A part 69 as shown in FIG. 22 is mounted on shaft 62 with a key and matching groove 70, such that part 69 can move along axis 61 and rotates with shaft 62. Part 69 is provided with a projection 71 that matches with groove 68 and slides in it. On an outer circumference of part 69, a groove 72 is provided. Another part 73 matching with groove 72 is attached to an actuator 74 that moves part 73 along axis 61.

Actuator 74 moves part 73, which slides in groove 72 without affecting rotation of part 69, and thus moves part 69 in direction 75 along axis 61. Movement of part 69 in direction 75 rotates assembly 67 about axis 61 through sliding of projection 71 within groove 68. Rotation of assembly 67 rotates bevel gear 66 that rotates meshing bevel gear 65. Rotation of gear 65 rotates nut 64 that moves threaded member 63 in direction 60 and thus moves axis 76 of disc 59 with respect to the shaft axis 61. Axis 61 and axis 76 are parallel to each other. Provisions are made in shaft 62 to block movement of nut 64 in direction 60 and allow it to rotate about axis 60. Surfaces 77 on disc 59, together with matching surfaces on shaft 62, blocks rotation of disc 59 about axis 60 and give support to the disc while allowing it to move along direction 60. Distance between axis 61 and axis 76 is the overall eccentricity of the assembly. Thus, movement of 73 changes overall eccentricity without affecting rotation of 69, 67, 64, and 59 around shaft axis 61. Holding 73 in one position correspondingly maintains overall eccentricity of the assembly.

In other arrangement, nut 64 can be fixed to shaft 62, and threaded part 63 is allowed to rotate about axis 60 without moving along axis 60 with respect to the disc 59; bevel gear 65 is mounted on threaded part 63 in such a way that it rotates with threaded part 63 while does not move along axis 60. Thus, movement of 73 along axis 61 rotates threaded part 63, and thus moves disc 59 along axis 60 and changes the distance between axes 61 and 76.

There can be different arrangements that can move disc 59 along a direction normal to axis 61 of shaft 62 to change distance between axis 61 and axis 76 of disc 59 as to change overall eccentricity of the assembly, while continuing rotation of assembly about shaft axis 61.

Various arrangements to move a disc in a direction normal to shaft axis: In above two examples the disc movement in a direction along the shaft axis is blocked, in yet another arrangement where the axial movement of the shaft or disc is allowed appropriate modifications can be incorporated in the arrangements described above. For example, surfaces 46, 47, 48, and 49 can be fixed to the shaft and the disc can be moved along the shaft axis with a collar fixed to the disc as in outer eccentric 32 shown in FIG. 14. In other words relative movement of a disc along shaft axis with respect to the shaft is converted to relative movement of the disc in direction normal to the shaft axis. In yet another arrangement, actuator 57, and 74 can be replaced with arrangement with a crank similar to that shown in FIG. 4 and FIG. 8 with appropriate design modifications. In other arrangements, an actuator can directly be put between the shaft and the disc as to move the disc with respect to the shaft in a direction normal to the shaft axis without the need of part 44, or assembly 67 and actuator 57 or 74 to do so.

Any suitable mechanism other than the above-mentioned mechanisms can also be used to move a disc in a direction normal to the shaft axis as to change the overall eccentricity while continuing rotation of shaft and the disc about shaft axis. Basic requirement of such a mechanism is that it should be able to control the movement of a disc in a direction normal to shaft axis as per the requirements of the output component that use the variable eccentricity assembly. Thus by controlling the movement of the disc in a direction normal to the shaft axis, with respect to the shaft, overall eccentricity of the assembly can be controlled.

External surface of the disc need not be cylindrical but should be a surface of revolution formed by revolution of a curve around an axis. A typical eccentric with non-cylindrical surfaces 78 and 79, is shown in FIG. 24. Internal surface 78 is formed by revolving a suitable curve around axis 80, similarly external surface 79 is formed by revolving another suitable curve around axis 81. The two axes 80 and 81 are axes of revolution for surfaces 78 and 79 respectively and are the first axis and the second axis respectively for the eccentric. Only surfaces 78 and 79 form the basic eccentric and thus are of interest, the eccentric may have some other surfaces but are not considered here. Non-cylindrical external surface 79 can be used as the external surface of disc 41 or disc 59.

In all the above arrangements proper use of lubrication and appropriate use of bearings improves performance of the arrangements and can be worked out by a person skilled in the art and thus not discussed here.

### Advantages of Assembly With Variable Eccentricity:

1. A variable eccentricity assembly in its basic form with at least two eccentrics in series can be used as a spacer or fastener to help joining two unaligned parts with ease. For an example, this type of spacer can be of much use while mounting a radiator in an automobile as it is to be mounted on the chassis of the vehicle and the mounting holes cannot maintain very accurate positions.

2. Variable eccentricity assembly finds application in eccentric gear boxes

3. Variable eccentricity assembly can be used to auto adjust the eccentricity to compensate wear and tear in a device. For example, a device that has one hollow ring inside which a disc of diameter smaller than that of the ring is moving with an eccentric such that disc external surface is rubbing on the internal surface of the ring. For this case, the eccentricity of the eccentric is half the difference between the two diameters. As wear and tear of the rubbing surfaces takes place eccentricity increases, this reduces contact pressure at the rubbing surfaces with a constant eccentricity drive. A variable eccentricity assembly instead of a constant eccentricity eccentric with maximum eccentricity of the assembly set to more than half the difference between the two diameters can be used to compensate for the wear and tear. Arrangement can be made to incorporate a tendency with appropriate magnitude towards increasing eccentricity of the variable eccentricity assembly, as to maintain rubbing pressure until due to wear and tear the difference between the two diameters becomes double the maximum eccentricity of the assembly.

4. In an eccentric gear drive, engagement and disengagement of the gear with external teeth and gear with internal teeth, or in case of an eccentric clutch, engagement and disengagement of the disc and the ring, can be controlled by varying eccentricity of the assembly. When the eccentricity of the assembly is made maximum the engagement takes place and when the eccentricity is made minimum, the disengagement can take place. If the eccentricity is made zero, then the inner gear with external teeth and the ring gear with internal teeth or the inner disc and the outer ring become coaxial and depending on their individual diameters, can be made to rotate without making contact.

5. A variable eccentricity assembly can be used in many applications where correction in eccentricity is beneficial.

6. In most of the applications where eccentrics are used, a variable eccentricity assembly in place of a constant eccentricity eccentric can be used, this will give adjustment of eccentricity to compensate wear of the eccentric itself. This will improve life of the device and improve performance of the device; this may also reduce maintenance cost.

1. A variable eccentricity assembly consisting of at least two eccentric parts;
wherein each eccentric part has first axis for its internal surface, a portion of which is a surface of revolution formed by revolving a curve around the first axis; and has a second axis for its external surface, a portion of which is a surface of revolution formed by revolving a curve around the second axis;
wherein eccentric parts are arranged in such a way that first axis of one eccentric part is aligned with second axis of an adjacent eccentric part.

2. A variable eccentricity assembly consisting of at least two eccentric parts, a mechanism, at least one shaft and an output component that relatively revolves around the shaft axis with a radius equal to the eccentricity obtained from the assembly;
wherein each eccentric part has first axis about which it can revolve, and has a second axis for external surface, a portion of which is a surface of revolution formed by revolving a curve around the second axis;
wherein eccentric parts are arranged in such a way that first axis of one eccentric part is aligned with second axis of an adjacent eccentric part;
wherein inner most eccentric part is connected to a shaft and the outer most eccentric part is connected to an output component;
wherein the mechanism rotates one eccentric part with respect to another eccentric part as to change relative angular position of the eccentric parts and thus change distance between shaft axis and the second axis of outer most eccentric part, which is the overall eccentricity of the variable eccentricity assembly.

3. A variable eccentricity assembly as in claim 2 in which the mechanism consists of a component, called as ring, and a flexible component with fixed length called as wire;
wherein the ring has its axis of rotation aligned to the shaft axis and is movable with respect to at least one of the eccentric parts in a direction along the axis of the shaft; ring rotates with one of the eccentric parts;
wherein one end of wire is fixed to one of the eccentric parts and other end is fixed to the ring and the wire is routed through the other eccentric part in such a way that a movement of the ring in axial direction causes corresponding relative rotation between the eccentric parts.
wherein either inner most eccentric part rotate with the shaft and outer most eccentric part rotate with respect to the output component, or inner most eccentric part rotate with respect to the shaft and outer most eccentric part rotates with the output component;

4. A variable eccentricity assembly as in claim 3 in which the wire with fixed length is replaced with a stretchable or compressible component with variable length.

5. A variable eccentricity assembly as in claim 2 in which the mechanism consists of an actuator that is mounted between two of the eccentric parts and actuation of the actuator gives relative rotation to the eccentric parts.

6. A variable eccentricity assembly as in claim 2 in which at least two of the eccentric parts have relative movement between them in a direction along the shaft axis; at least one of the eccentric parts is movable with respect to the shaft in a direction along the shaft axis;
wherein the mechanism converts relative axial movement between the two eccentric parts to corresponding relative rotation between them;
wherein either inner most eccentric part rotate with the shaft and outer most eccentric part rotate with respect to the output component, or inner most eccentric part rotate with respect to the shaft and outer most eccentric part rotates with the output component;
wherein relative axial movement between the eccentric parts is controlled to control corresponding relative angular position of them as to control overall eccentricity of the variable eccentricity assembly.

7. A variable eccentricity assembly which consists of at least one shaft, one output component, one circular disc and a mechanism;
wherein the circular disc is mounted on the output component as to rotate with respect to it; the disc is also mounted on the shaft through the mechanism to move the disc with respect to the shaft axis;
wherein the disc has a portion of the external surface as a surface of revolution formed by revolving a curve around an axis; distance between the axis and shaft axis is the overall eccentricity of the assembly;
wherein the mechanism moves the disc in a direction normal to the shaft axis as to change overall eccentricity of the assembly.

8. A variable eccentricity assembly as explained in claim 7, in which the mechanism consists of an intermediate part that is movable in a direction along the axis of the shaft and rotates with the shaft;
wherein the disc is mounted on the intermediate part in such a way that it rotates with the intermediate part and does not move with respect to the shaft in a direction along the axis of the shaft;
wherein movement of the intermediate part along the axis of the shaft is converted to corresponding movement of the disc in a direction normal to the shaft axis;
wherein movement of the disc in direction normal to the shaft axis is controlled by the axial movement of the intermediate part as to control overall eccentricity of the variable eccentricity assembly.

9. A variable eccentricity assembly as explained in claim 7, in which the mechanism consists of a first threaded member connected to the shaft in such a way that it does not move in a direction normal to the shaft axis, and a second threaded member with matching threads to that of the first threaded member, is connected to the disc;
wherein first threaded member is fixed to the shaft and the second threaded member can rotate with respect to the disc or first threaded member can rotate with respect to the shaft and the second threaded member is fixed to the disc;
wherein relative rotation between the first and second threaded members results in movement of disc in a direction normal to the shaft axis; and overall eccentricity of the assembly is controlled by controlling the relative rotation between the first and second threaded members.

10. A variable eccentricity assembly as in claim 9, in which the mechanism has additional first member movable in the direction along the shaft axis; axial movement of first member correspondingly rotates an additional second member with respect to the shaft; rotation of second member is converted to the corresponding relative rotation between first and second threaded members;
Wherein overall eccentricity of the assembly is controlled by controlling the axial movement of the additional first member.
